(19) United States
(12) Patent Application Publication
(10) Pub. No.: US 2010/0229761 A1
(43) Pub. Date: Sep. 16, 2010

(54) CEMENT COMPOSITION FOR SELF-LEVELLING CONCRETE AND SELF-LEVELLING CONCRETE CONTAINING SUCH COMPOSITION

(75) Inventor: Faber Fabbris, Paris (FR)

Correspondence Address: YOUNG & THOMPSON, 209 Madison Street, Suite 500, Alexandria, VA, 22314, US

(73) Assignee: CIMENTS FRANCAIS, Puteaux (FR)

(21) Appl. No.: 12/671,073

(22) PCT Filed: Jul. 28, 2008
(86) PCT No.: PCT/FR08/01127

§ 371 Date: Mar. 31, 2010

(30) Foreign Application Priority Data
Jul. 30, 2007 (FR) 0705568

(51) Int. Cl. C04B 24/38

(52) U.S. Cl. 106/805

(57) ABSTRACT

A cement composition for a self-levelling concrete, includes a mixture of rheology-modifying additives, the combination of at least a first agent for substantially increasing the shear threshold of the concrete in the fluid state, selected from a natural polysaccharide ether, a hydroxyalkyl guar ether, a hydroxyethylcellulose or a hydroxypropyl guar, which are hydrophobically modified with the introduction of hydrophobic side grafts, and at least a second viscosity-increasing agent for substantially increasing the viscosity of the concrete in the fluid state, selected from a non-hydrophobically-modified hydroxyalkylcellulose having a degree of polymerization between approximately 500 and approximately 4500 and a viscosity of less than 50 PA·s in aqueous solution at 2 wt.-% and a poly (ethylene oxide), in order to limit or prevent the dynamic segregation of granulates in the concrete during the implementation thereof. The use of such a composition can replace the presence of a filler in the concrete, in particular a self-levelling concrete, without diminishing the performance concerning the spreading thereof, the sieve stability, the bleeding and the dynamic segregation relative to a concrete containing a filler, in particular a concrete having the same water/cement ratio.

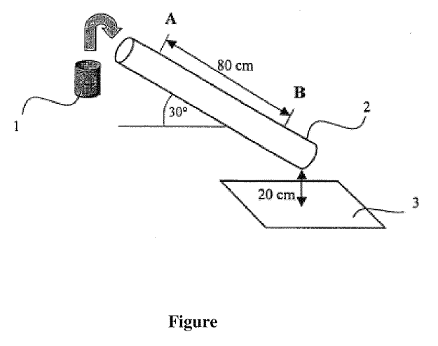

This invention relates to a cement composition for self-placing concrete that contains a mixture of rheology-modifying adjuvants and the self-placing concrete that contains such a composition.

The self-placing concretes are very fluid, homogeneous and stable concretes that are used without vibrations, compacting being performed under the action of gravity alone. The self-leveling concretes constitute a particular family of self-placing concretes that correspond to horizontal applications such as coatings, paving, or floors.

These concretes contain granulates (of a size that can range up to approximately 20 mm) that are coated in a cement composition that comprises a hydraulic binder, for example Portland cement, and at least one adjuvant that is preferably a liquefier or superplasticizer that imparts to the mixture increased fluidity that is close to that of a liquid. This explains the self-leveling or self-placing nature of said concrete.

These concretes have a capacity for molding, coating and advantageous compacting. They are highly valued in the fields of construction and building owing to their appearance and their capacity to “compensate for” unequal levels, to place themselves in the iron framework and to coat, for example, ground heating lines, without application of external vibrations that are generally in use in the traditional construction techniques. These compositions are also generally valued for their facility of use because it is possible to pump the fresh concrete to heights of several hundred meters, which prevents the handling of various components in the immediate proximity of the application and eliminates the vibration operations by thus optimizing the costs and the organization of the worksite.

However, this fluidity property of the self-placing concrete should be obtained without causing problems of sweating or sedimentation of granulates.

The stability of these concretes is usually achieved by introducing solid mineral components called fillers into their formulations, as mentioned in the NF EN 206-1 standard. These fillers are siliceous or calcareous inert products in the form of particles of small grain size, preferably of a size that is less than or equal to the grain size of cement, i.e., generally between 0.10 μm and 100 μm. By filling in the spaces between the cement particles, the fillers improve the compactness of the concrete. They are used in particular in the self-placing concretes with low mechanical strength, i.e., for example, from class 25 to 30 MPa in 28 days. Their proportion in a concrete can reach 5 to 10% by weight of the total mass of concrete.

The introduction of filler in the self-placing concrete formulations is particularly necessary in the case of the concretes that belong to the lowest classes of resistance to compression. Actually, in the self-placing concretes, whereby the water/cement ratio is high, the solid volumetric fraction of the concrete is smaller, and the risks of segregation and sweating are more significant.

As always for the purpose of increasing the stability with regard to the segregation and/or the sweating, the self-placing concretes frequently contain, in addition to the mineral additions that are cited (fillers), and in addition to liquefying or superplasticizing agents, agents of various chemical natures that make it possible to control the rheology of the composition, commonly called “thickeners” or “agents of stability.”

The object of the “thickening” agents is to improve the stability of the self-placing concretes with regard to the segregation and/or the sweating; these are often macromolecules, in particular cellulose derivatives such as cellulose ethers or other polysaccharides, or else synthesis polymers such as (ethylene) poly(oxide), or polyvinyl alcohols. They have the advantage of modifying the rheological behavior (among other things by increasing the viscosity) of the cement composition. These are, however, molecules that have a very high viscosity in aqueous solution (beyond 70 to 100 Pa·s in aqueous solution at 2% by weight).

In addition, so as to improve the workability of the concrete, in particular so as to increase its spread, it is possible to increase the proportion by superplasticizing the formula. This larger proportion of superplasticizer can, however, create undesirable actions such as a non-uniform distribution of granulates within the mixed concrete, segregation, and/or a sweating. The self-placing concrete can therefore exhibit problems of stability or cohesion during its implementation and/or immediately after its installation.

The very action mechanism of these superplasticizers (deflocculation), responsible for the increase of spread, can be at the origin of instability of the concrete in the fresh state. In particular, the reduction of the shear threshold generated by the superplasticizer leads to a reduction of the field of reversible elastic deformation of the cement paste (namely, here, the water, cement, filler unit). This phenomenon limits the capacity of the cement paste to retain within itself granulates that are subjected to gravity (segregation at rest). This drawback is accentuated when the size of the granulates increases: in particular, in the concretes that contain granulates of a size that can range up to 20 mm relative to the mortars that contain sand with a grain size that is less than or equal to 6 mm.

Parallel to this reduction of the flow threshold, the strong proportions of superplasticizer can produce a lowering of the viscosity of the cement paste and therefore of the concrete. This reduction of the viscosity exposes the concrete—when it is subjected to a flow (in particular during its pumping or its installation)—to phenomena of instability and dynamic segregation that cannot necessarily be observed at rest.

These two phenomena of heterogeneity and segregation at rest and in the dynamic state degrade the correct implementation of the self-placing concrete.

To prevent these problems, two types of measures have been provided in the prior art:

1) Increasing the Solid Volumetric Fraction within the Cement Paste.
This is achieved with cement contents that are larger than those recommended for the desired mechanical strengths or by the introduction of fine mineral additions with or without hydraulic activity (such as calcareous fillers, fly ashes, . . . ). This increase of the solid fraction has the effect of increasing the compacting of the mixture by thus precluding the segregation at rest; the viscosity of the resulting mixture is thus increased. This makes it possible to reduce the risk of segregation and/or instability of the concrete in the fresh state.

2) Introducing Specific Adjuvants that Directly Activate the Concrete Rheology.
These are the adjuvants that are part of very different chemical families that are known under the names of stability (or cohesion) agents, thickening agents or viscosing agents. These definitions should be considered as purely conventional, because the great majority of these adjuvants have actions that are readily more complex and differentiated on the rheology of the concrete than a simple increase in viscosity.

The introduction of specific adjuvants that activate the rheology of the concrete is, in practice, always complementary with the introduction of filler.

The proportion of filler being generally between 30 and 45% by weight relative to the cement, which corresponds to a content that can reach 5 to 10% by weight of the entire concrete, its introduction represents a significant cost (supplying, transport, handling, . . . ).

In addition, the metering of the adjuvants, in a self-placing concrete formula, is often difficult because of the effect on the rheological properties of the concrete. It is actually common that these adjuvants have an effect both on the shear threshold and on the viscosity. Based on their metering, the relative significance of the variation of the shear threshold and the viscosity is different: low concentrations of these adjuvants may have a prevailing effect on the shear threshold and a minimal effect on the viscosity; with higher doses, these effects can be reversed.

It may therefore happen that the objective of increasing the viscosity of the concrete (to prevent instability during its installation) is achieved at the cost of a higher shear threshold and therefore at the cost of a reduction of the spread.

During recent studies on various rheology-modifying adjuvants, activating the shear threshold and the viscosity, it was discovered, surprisingly enough, that the combination of two particular agents made it possible to impart unexpected properties to the cement composition and therefore to the concrete, in particular making it possible to considerably reduce the filler content and even to eliminate the presence of filler in said concrete.

For this purpose, this invention relates to a cement composition for self-placing concrete that comprises a cement, a superplasticizer, and a mixture of rheology-modifying adjuvants, characterized in that said mixture comprises the combination:
Of at least a first agent that primarily increases the shear threshold of the concrete in the fluid state that is selected from among a natural polysaccharide ether, a hydroxyalkyl guar ether, a hydroxyethyl cellulose or a hydroxypropyl guar, hydrophobically modified by introduction of hydrophobic lateral grafts, and
At least a second viscosing agent that primarily increases the viscosity of said concrete in the fluid state, selected from among a hydroxyalkyl cellulose, hydrophobically non-modified, with a degree of polymerization of between approximately 500 and approximately 4,500, having a viscosity that is less than 50 Pa·s in an aqueous solution at 2% by weight, and an (ethylene) poly(oxide)
   limiting or preventing the dynamic segregation of granulates in the concrete during its implementation and making it possible to reduce the filler content in the concrete to a value that is less than 20% by weight relative to the cement.

These two agents each have a specific, selective and separate action.

“Agent that increases the shear threshold” is defined here as an agent for modifying the rheology of the fluid concrete, primarily activating the shear threshold without altering the other rheological parameters of this concrete, in particular its differential viscosity.

“Viscosing agent” is defined here as an agent whose primary effect of its addition to the concrete is the increase of the differential viscosity of the concrete in the fluid state.

“Concrete in the fluid state” is defined here as the concrete that is obtained immediately after mixing, i.e., after water is added to the hydraulic binder (cement) and milling, but before the beginning of the setting of said cement.

Throughout the text, “modified” is defined as the grafting of lateral grafts on the polymer skeleton, for example functional groups or hydrophobic lateral chains; advantageously, the grafts are C₄-C₃₀ alkyl chains (i.e., chains that may or may not be branched, comprising 4 to 30 carbon atoms) and “hydrophobically modified” is defined as the presence of such hydrophobic grafts.

These agents are very water-soluble. Surprisingly enough, however, the inventor noted that the aqueous solutions that contain the second agent, and more particularly the above-mentioned hydroxyalkyl celluloses, have a low viscosity—namely a viscosity at 25° C. less than approximately 50 Pa·s (preferably less than 10 Pa·s or preferably also less than 5 Pa·s), at a concentration of 2% by weight in water—and are more effective for limiting or preventing the dynamic segregation of granulates than the hydroxyalkyl celluloses that are hydrophobically non-modified with a degree of polymerization that is greater than 5,000, and, in aqueous solution, at the same concentration, have a viscosity of more than approximately 70 or 100 Pa·s.

The second agent is advantageously a hydroxyalkyl cellulose, hydrophobically non-modified, with a degree of polymerization of between approximately 500 and approximately 4,000.

Preferably, the (ethylene) poly(oxide) has a molecular weight of between 1,000,000 and 5,000,000, preferably between 2,500,000 and 4,000,000, and more preferably between 3,000,000 and 3,500,000.

It appeared that the combined synergetic effects on the shear threshold and the viscosity of the concrete in the fluid state are observed in particular when the composition advantageously contains up to 1%, preferably up to 0.1%, by weight of cement of said first agent and up to 5%, preferably up to 2%, by weight of cement, and even more preferably up to 1% by weight of cement of said second agent.

This invention also relates to any self-placing concrete that contains a cement composition as described above, and a filler content that is less than or equal to 20% by weight of cement, preferably a filler content that is less than 10% by weight of cement, and even more preferably less than 5% by weight of cement, and even very advantageously without any addition of filler.

Such a mixture of adjuvants, according to this invention, actually makes it possible, surprisingly enough, to make the presence of filler unnecessary in a concrete, in particular a self-placing concrete, without reducing performance levels relative to the spread, the sieve stability, sweating, or dynamic segregation, relative to a concrete with filler, in particular a concrete with the same water/cement ratio, i.e., the same strength class.

This reduction of the filler content, and even this absence of adding filler offers an enormous advantage in the field of concrete by eliminating an important component in terms of volume, weight and handling (transport, storage, and other logistical aspects), and therefore leads to a considerable simplification of the implementation of concrete at a reduced cost.

This invention also relates to the use of a mixture that comprises:
At least a first agent that primarily increases the shear threshold of the concrete in the fluid state that is selected from among a natural polysaccharide ether, a hydroxyalkyl guar ether, a hydroxyethyl cellulose or a hydroxypropyl guar, hydrophobically modified by the introduction of hydrophobic lateral grafts, and
At least a second viscosing agent that primarily increases the viscosity of said concrete in the fluid state, selected from among a hydroxyalkyl cellulose, hydrophobically non-modified, with a degree of polymerization of between approximately 500 and approximately 4,500 having a viscosity that is less than 50 Pa·s in aqueous solution at 2% by weight, and an (ethylene) poly(oxide)
   to make the presence of filler particles unnecessary in a self-placing concrete without reducing the performance levels relative to the spread, sweating, and the dynamic segregation of the granulates.

This invention will be illustrated using the following non-limiting examples.

The single figure presents a diagram of the equipment for the “chute test.”

### Starting Components

Cements: although the invention can be applied to any type of cement, the tested cements were Portland cements,
The filler was a calcareous filler, preferably in crushed form, with a grain size of between 1 and 100 μm,
Cohesion agent: for the referenced examples, in addition to the action of the filler, it has the essential role of limiting the segregation of the concrete at rest; the agent that is used here is marketed under the name COLLAXIM L10 by the AXIM Company,
Granulates that are preferably of siliceous or silicocalcareous type characterized by two or more granulometric classes and always by Dₘₐₓ≦20 mm,
Superplasticizer: it is of the acrylic carboxylic acid copolymer type with acrylic esters, for example such as the one that is marketed under the name Cimfluid duo 1001 by the Axim Company.

In the examples below, the effective water/cement ratio has been specified because it is important for the final mechanical strength of the concrete.

The volume of the cement paste (except for granulates) is identical after mixing (addition of water) so as to better compare the tested compositions, the corresponding reference compositions (with filler), and the compositions that contain a single agent or agents that are different from those of this invention (comparative examples).

### Executed Tests

Spread: the spread was measured with the Abrams cone (according to the EN 12350-2 standard)
Chute test: this is a test that was developed in the laboratory so as to attempt to demonstrate the dynamic segregation and then to compare the effects of different adjuvants. A diagram of the equipment that is necessary for the implementation of this test is presented in the single figure. This test consists in pouring a bucket 1 (2 liters) of concrete that is to be tested immediately after mixing with water into a pipe 2 that is 15 cm in diameter and 110 cm in length, tilted by 30 degrees relative to the horizontal line. The outlet of the pipe 2 is centered above a spread plate 3 that is arranged at 20 cm. This test makes it possible to obtain information that is both quantitative and qualitative: the flow time (i.e., the interval of time that is necessary to the concrete front to travel the distance between the reference points A and B, separated by 80 cm), and the appearance of the concrete during and after its spread (in the form of a “slab”) on the spread plate 3.

(This aspect is evaluated starting from visual criteria, relative to the shape of the slab and the homogeneity of the concrete).

It is considered that the concrete is affected by a dynamic segregation if the spread slab has an asymmetrical shape or if a paste/granulate separation is observed.
Sieve stability index: the test is executed according to the indications of the draft of the EN 12350-11 standard;
Sweating: sweating is assessed visually.
The tested rheology-modifying agents are as follows:

1^{st} agent: agent that primarily increases the shear threshold of the fluid concrete:
The NEXTON compound that is marketed by the AQUALON-HERCULES Company is a modified natural polysaccharide whose primary chain is the cellulose (β-D-glucose) that is etherified by means of a strong base and ethylene oxide to obtain a hydroxyethyl cellulose (HEC) and introduction of alkyl chains that lead to the formation of hydrophobically modified hydroxyethyl cellulose (HMHEC); the number of substituents (MNS) per β-D-glucosidic unit is on the order of 2.5.
ESACOL MX 144, this product that is marketed by the LAMBERTI Company, is a polysaccharide whose primary chain is guar gum (repetitive unit that consists of β-D-mannose and α-B-galactose) that has undergone etherification with propylene oxide that leads to the formation of hydroxypropyl guar (HPG) that has a number of substituents per unit that is greater than 2.5. This product has been hydrophobically modified by introduction of side chains.
As comparative examples, ESACOL HS26 and ESACOL HS30 that are marketed by the LAMBERTI Company and that are molecules of hydroxypropyl guar or hydroxyalkyl guar type, but are hydrophobically non-modified, have been tested. These molecules impart to the cement composition comparable modifications of the viscosity and shear threshold parameters and therefore do not have a primary action on the shear threshold.
   2^{nd} Agent: agent that primarily increases the viscosity:
A natural polysaccharide that is modified with a primary cellulose chain (β-D-glucose) that is etherified by means of a strong base and ethylene oxide to obtain a hydroxyethyl cellulose (HEC) with a number of moles of substituents (MS) per unit of β-D-glucose of 2.5 and variable polymerization degrees (PD).

In the examples according to this invention, NATROSOL 250 GXR, which is an HEC with a degree of polymerization of approximately 1,000, and NATROSOL 250 HXR, which is an HEC with a degree of polymerization of approximately 3,700, have been used. These water-soluble products have a low viscosity, including at concentrations that range up to 2% by weight in the water:

| | |
|---|---|
| Natrosol 250 GXR: at | 0.5% by weight in water = 8.5 · 10⁻³ Pa · s |
| | 1% by weight in water = 0.035 Pa · s |
| | 2% by weight in water = 0.26 Pa · s |
| Natrosol 250 HXR: at | 1% by weight in water = 2 Pa · s |
| | 2% by weight in water = 30 Pa · s |

An (ethylene) poly(oxide) as marketed under the name ALKOX E-130 of the MEISEI CHEMICAL WORKS LTD Company (molecular weight of between 3,000,000 and 3,500,000), soluble in water;
As a comparative example, NATROSOL 250 HHXR, which has a higher degree of polymerization, namely between approximately 4,800 and 5,000, has been tested. This compound imparts to the cement composition comparable modifications of the viscosity and shear threshold parameters and therefore does not exhibit a primary action on the viscosity. In addition, NATROSOL 250 HHXR in aqueous solution has a viscosity that increases significantly with its concentration, namely 7 Pa·s at 1%, 50 Pa·s at 1%, and 300 Pa·s at 2% by weight in water.

The “NATROSOL” compounds are marketed by the AQUALON-HERCULES Company.

The viscosities that are noted above have been measured on a rheometer with imposed constraint (AR 1000 of TA Instruments) with a flat cone geometry with a 2° opening.

In the examples that are presented, the agents for modifying rheology (1^{st} agent and 2^{nd} agent) are added, as well as the superplasticizer, after water is introduced into the cement mixture. As a variant, it is possible to start from a “premix,” i.e., a cement composition that contains cement, superplasticizer, 1^{st} and 2^{nd} agents; to which granulates and water will then be added on site.

In all of the examples below, the content of cement, water, filler and granulate is expressed in Kg/m³; the content of superplasticizer, cohesion agent, and 1^{st} and 2^{nd} agents is expressed in % by weight of cement.

The tests that were considered as acceptable in this invention were:
For the spread t₀, a value that is greater than or equal to 630 mm, whereby the desired spread for the self-placing concretes is generally greater than or equal to 600 mm,
The sieve stability is to be less than 30%,
An absence of sweating and an absence of dynamic sweating should be noted
As well as a time in the chute of between 2 and 10 s, preferably between 2 and 7 s, and even more preferably between 4 and 6 s.

### EXAMPLE 1 (FOR COMPARISON)—EXAMPLE 2 (FOR COMPARISON)—EXAMPLE 3 (REFERENCE)—EXAMPLE 4 (INVENTION)

In a first step, comparison examples have been implemented with only one of the agents. Comparison Example 1 only used the agent that increases the shear threshold and Comparison Example 2 only used the agent that increases only the viscosity.

Table 1 shows the results of these two Comparison Examples 1 and 2 with an Example 4 that includes a combination of the two agents, in reference with a composition that contains a filler in the presence of a cohesion agent. This last composition, named “Example 3 (Reference)” in all of the tables, is formulated according to the prior art.

It is noted that in Comparison Example 1 that contains only the agent that increases the shear threshold, the time in the chute is less than 1 s, which reflects an inadequate viscosity and a sieve stability that is more than 50%. In addition, sweating and a dynamic segregation are noted.

A dynamic segregation is also observed at the end of the pouring of the concrete according to Comparison Example 2 that contains only an agent that increases the viscosity.

Comparable sieve stability values are observed for Reference Example 3 with filler and Example 4 according to this invention without filler, including the combination of two agents.

TABLE 1

| | Example 1 | | Example 3 | |
|---|---|---|---|---|
| | (Com- | Example 2 | (Ref- | |
| | parison) | (Comparison) | erence) | Example 4 |
| CEM II 32.5 R | 376 | 376 | 300 | 376 |
| Cement | | | | |
| Effective Water | 227 | 227 | 180 | 227 |
| Filler | 0 | 0 | 192 | 0 |
| Granulates | 1,654 | 1,654 | 1,654 | 1,654 |
| Superplasticizer | 1.0% | 1.0% | 2.0% | 1.0% |
| Cohesion Agent | | | 0.05% | |
| 1^{st} Agent | | | | |
| (Threshold) | | | | |
| ESACOL MX | 0.02% | | | 0.025% |
| 144 | | | | |
| 2^{nd} Agent | | | | |
| (Viscosing) | | | | |
| NATROSOL | | 0.05% | | 0.05% |
| 250 GXR | | | | |
| Effective | 0.6 | 0.6 | 0.6 | 0.6 |
| Water/Cement | | | | |
| Volume of | 370 L | 370 L | 370 L | 370 L |
| Paste | | | | |
| Spread at tₒ | 650 mm | 695 mm | 720 mm | 680 mm |
| Time in the | <1 s | 6 s | 4.5 s | 6.5 s |
| Chute | | | | |
| Sieve Stability | >50% | >50% | 27% | 23% |
| Sweating | Present | Absent | Absent | Absent |
| Dynamic | Present | Present at the | Absent | Absent |
| Segregation | | End of the | | |
| | | Pouring | | |

### EXAMPLES 5, 6 AND 7

Different concentrations of the agent increasing the shear threshold and the viscosing agent are presented in Table 2. Variable contents of these two agents have been tested in Examples 5, 6 and 7.

TABLE 2

| | Example 3 | | | |
|---|---|---|---|---|
| | (Reference) | Example 5 | Example 6 | Example 7 |
| CEM II 32.5 R | 300 | 376 | 376 | 376 |
| Cement | | | | |
| Effective Water | 180 | 227 | 227 | 227 |
| Filler | 192 | 0 | 0 | 0 |
| Granulates | 1,654 | 1,654 | 1,656 | 1,654 |
| Superplasticizer | 2.0% | 0.6% | 0.8% | 1.0% |
| Cohesion Agent | 0.05% | | | |
| 1^{st} Agent | | | | |
| (Threshold) | | | | |
| ESACOL MX 144 | | 0.015% | 0.02% | |
| NEXTON | | | | 0.02% |
| 2^{nd} Agent | | | | |
| (Viscosing) | | | | |
| NATROSOL | | 0.3% | 0.5% | |
| 250 GXR | | | | |
| NATROSOL | | | | 0.05% |
| 250 HXR | | | | |
| Effective | 0.6 | 0.6 | 0.6 | 0.6 |
| Water/Cement | | | | |
| Volume of | 370 L | 370 L | 370 L | 370 L |
| Paste | | | | |
| Spread at t₀ | 720 mm | 650 mm | 665 mm | 630 mm |
| Time in the | 4.5 s | 4 s | 5 s | 2.12 s |
| Chute | | | | |
| Sieve Stability | 27% | 16% | 14% | 12% |
| Sweating | Absent | Absent | Absent | Absent |
| Dynamic | Absent | Absent | Absent | Absent |
| Segregation | | | | |

It is noticed that the performance levels are comparable regardless of these concentrations, whereby these concentrations are preferably less than 0.05% by weight for the 1^{st} agent and less than or equal to 0.5% by weight for the 2^{nd} agent. It is therefore possible by the combination of these two agents to obtain a self-placing concrete without filler with performance levels that are equal to a self-placing concrete that contains a filler.

### COMPARATIVE EXAMPLES 8, 9 AND 10

Table 3 exhibits other comparative examples in which compositions that contain different molecules have been tested by modifying one of the two agents, either the agent that increases the shear threshold or the agent that increases the viscosity.

TABLE 3

| | Example 3 | Example 8 | Example 9 | Example 10 |
|---|---|---|---|---|
| | (Reference) | (Comparison) | (Comparison) | (Comparison) |
| CEM II 32.5 R | 300 | 376 | 376 | 376 |
| Cement | | | | |
| Effective Water | 180 | 227 | 227 | 227 |
| Filler | 192 | 0 | 0 | 0 |
| Granulates | 1,654 | 1,654 | 1,654 | 1,654 |
| Superplasticizer | 2.0% | 1.0% | 1.0% | 1.0% |
| Cohesion Agent | 0.05% | | | |
| 1^{st} Agent (Threshold) | | | | |
| ESACOL HS30 | | 0.05% | | |
| ESACOL MX 144 | | | 0.02% | |
| ESACOL HS 26 | | | | 0.02% |
| 2^{nd} Agent | | | | |
| (Viscosing) | | | | |
| NATROSOL | | 0.05% | | 0.045% |
| 250 GXR | | | | |
| NATROSOL | | | 0.06% | |
| 250 HHXR | | | | |
| Effective | 0.6 | 0.6 | 0.6 | 0.6 |
| Water/Cement | | | | |
| Volume of | 370 L | 370 L | 370 L | 370 L |
| Paste | | | | |
| Spread at tₒ | 720 mm | 610 mm | 560 mm | 680 mm |
| Time in the | 4.5 s | 2.8 s | 12.5 s | 2.3 s |
| Chute | | | | |
| Sieve Stability | 27% | 35% | 21% | 38% |
| Sweating | Absent | Absent | Absent | Present |
| Dynamic | Absent | Present | Absent | Present |
| Segregation | | | | |

When only one of the agents according to the invention is present, the performance levels are not listed regarding in particular the dynamic segregation that is present in the Comparison Examples 8 and 10 or regarding the time in the chute in Comparative Example 9.

### EXAMPLE 11 (REFERENCE WITH FILLER) AND EXAMPLE 12

A Portland cement that is different primarily relative to its strength class, namely a CEM II 45.5 R cement, has been tested. The results are presented in Table 4.

TABLE 4

| | Example 11 | |
|---|---|---|
| | (Reference) | Example 12 |
| CEM II 45.5 R Cement | 340 | 391 |
| Effective Water | 187 | 215 |
| Filler | 120 | 0 |
| Granulates | 1,665 | 1,665 |
| Superplasticizer | 3.30% | 2.750% |
| 1^{st} Agent (Threshold) | | |
| ESACOL MX 144 | | 0.056% |
| 2^{nd} Agent (Viscosing) | | |
| NATROSOL 250 GXR | | 0.095% |
| Effective Water/Cement | 0.55 | 0.55 |
| Volume of Paste | 374 L | 374 L |
| Spread at tₒ | 665 mm | 680 mm |
| Time in the Chute | 2.30 s | 2.67 s |
| Sieve Stability | 12% | 17% |
| Sweating | Absent | Absent |
| Dynamic Segregation | Absent | Absent |

The mixing of the two agents according to the invention is also effective for such a cement. The performance levels that are obtained are equivalent to a concrete that contains a filler (Reference Example 11).

### EXAMPLE 13

In Table 5, Example 13 presents the use of (ethylene) poly(oxide) as the second agent, namely the agent that increases the viscosity. It is quite advantageous for such concretes and makes it possible to obtain performance levels that are equivalent to Reference Example 3, namely a concrete with a filler.

TABLE 5

| | Example 13 | Example 3 (Reference) |
|---|---|---|
| CEM II 32.5 R Cement | 376 | 300 |
| Effective Water | 227 | 180 |
| Filler | 0 | 192 |
| Granulates | 1,654 | 1,654 |
| Superplasticizer | 1.0% | 2.0% |
| Cohesion Agent | | 0.05% |
| 1^{st} Agent (Threshold) | | |
| ESACOL MX 144 | 0.02% | |
| 2^{nd} Agent (Viscosing) | | |
| (Ethylene) poly(oxide) | 0.5% | |
| Effective Water/Cement | 0.6 | 0.6 |
| Volume of Paste | 370 L | 370 L |
| Spread at tₒ | 715 mm | 720 mm |
| Time in the Chute | 3.7 s | 4.5 s |
| Sieve Stability | 22% | 27% |
| Sweating | Absent | Absent |
| Dynamic Segregation | Absent | Absent |

It is therefore clear from all of the results thereof that synergy is achieved by the combined use of the first agent that increases the shear threshold and the second agent that increases the viscosity at very low contents relative to the cement, making it possible to make the presence of a filler totally unnecessary in a self-placing concrete.

In all of these results, the mechanical strengths at 28 days were on the order of 28 to 30 MPa, as predicted.

1. Cement composition for self-placing concrete that comprises a cement, a superplasticizer, and a mixture of rheology-modifying adjuvants, characterized in that said mixture comprises the combination:
Of at least a first agent that primarily increases the shear threshold of the concrete in the fluid state that is selected from among a natural polysaccharide ether, a hydroxyalkyl guar ether, a hydroxyethyl cellulose or a hydroxypropyl guar, hydrophobically modified by introduction of hydrophobic lateral grafts, and
At least a second viscosing agent that primarily increases the viscosity of said concrete in the fluid state, selected from among a hydroxyalkyl cellulose, hydrophobically non-modified, with a degree of polymerization of between approximately 500 and approximately 4,500, having a viscosity that is less than 50 Pa·s in an aqueous solution at 2% by weight, and an (ethylene) poly(oxide)
limiting or preventing the dynamic segregation of granulates, in the concrete during its
implementation and making it possible to reduce the filler content in the concrete to a
value that is less than 20% by weight relative to the cement.

2. Cement composition for self-placing concrete according to claim 1, wherein the grafts of the first agent are C₄-C₃₀ alkyl chains.

3. Cement composition for self-placing concrete according to claim 1, wherein the (ethylene) poly(oxide) has a molecular weight of between 1,000,000 and 5,000,000.

4. Cement composition for self-placing concrete according to claim 3, wherein the (ethylene) poly(oxide) has a molecular weight of between 2,500,000 and 4,000,000.

5. Composition according to claim 1, wherein it contains up to 1%, preferably up to 0.1%, by weight of cement of the first agent and up to 5%, preferably up to 2%, by weight of cement of the second agent.

6. Self-placing concrete, wherein it contains a cement composition according to claim 1, and a filler content that is less than or equal to 20% by weight of cement.

7. Self-placing concrete according to claim 6, wherein it contains a filler content that is less than 10% by weight, preferably less than 5% by weight of the cement.

8. Method of using a mixture that comprises:
At least a first agent that primarily increases the shear threshold of the concrete in the fluid state that is selected from among a natural polysaccharide ether, a hydroxyalkyl guar ether, a hydroxyethyl cellulose or a hydroxypropyl guar, hydrophobically modified by the introduction of hydrophobic lateral grafts, and
At least a second viscosing agent that primarily increases the viscosity of said concrete in the fluid state, selected from among a hydroxyalkyl cellulose, hydrophobically non-modified, with a degree of polymerization of between approximately 500 and approximately 4,500 having a viscosity that is less than 50 Pa·s in aqueous solution at 2% by weight, and an (ethylene) poly(oxide)
to make the presence of filler particles unnecessary in a self-placing concrete without reducing the performance levels relative to the spread, sweating, and the dynamic segregation of the granulates.

9. Cement composition for self-placing concrete according to claim 2, wherein the (ethylene) poly(oxide) has a molecular weight of between 1,000,000 and 5,000,000.

10. Cement composition for self-placing concrete according to claim 9, wherein the (ethylene) poly(oxide) has a molecular weight of between 2,500,000 and 4,000,000.
